(19) United States
(12) Patent Application Publication
(10) Pub. No.: US 2025/0296894 A1
(43) Pub. Date: Sep. 25, 2025

(54) AGRICULTURAL FERTILIZER COMPOSITION, METHOD OF MAKING AND USE THEREOF

(71) Applicants: Morehouse School of Medicine, Atlanta, GA (US); DevMar Products, LLC, Nashville, TN (US)

(72) Inventors: Rick L. CHRISTIAN, Crossville, TN (US); James W. LILLARD, JR., Smyrna, GA (US); Sharon W. REYNOLDS, Brentwood, TN (US)

(73) Assignees: Morehouse School of Medicine, Atlanta, GA (US); DevMar Products, LLC, Nashville, TN (US)

(21) Appl. No.: 19/082,804

(22) Filed: Mar. 18, 2025

Related U.S. Application Data
(60) Provisional application No. 63/567,073, filed on Mar. 19, 2024.

(51) Int. Cl. C05F 11/08; C05D 9/02; C05G 3/40; C05G 3/60; C05G 5/12; C05G 5/30

(52) U.S. Cl. CPC C05F 11/08; C05D 9/02; C05G 3/40; C05G 3/60; C05G 5/12; C05G 5/37

(57) ABSTRACT

A method for formulating an agricultural fertilizer composition contains the step of coating a granular absorbent material with a coating agent to produce a coated absorbent material and mixing the coated absorbent material with an absorbable agent, wherein the coated absorbent material absorbs the absorbable agent to form the agricultural fertilizer composition. In one aspect, agricultural fertilizer compositions that can absorb liquids in many applications, including agricultural, horticultural and fertilizer purposes, are also disclosed.

This application claims priority from U.S. Provisional App. No. 63/567,073, filed Mar. 19, 2024, which is incorporated herein by reference.

### FIELD

The present application generally relates to agricultural fertilizer compositions and methods for agricultural, or for horticultural, or for farming purposes.

### BACKGROUND

Typically, different types of agents have been utilized as horticultural agents or fertilizers, in a variety of industries, including the agricultural and food preparation industries, for some time. There is a need for agents that effectuate a safer, more cost effective and/or convenient means of eliminating potentially harmful germs, viruses, funguses and bacteria. However, the inherent strength of the certain agents has at times resulted in effectiveness and cost outweighing safety. Consequently, great care must be taken by the user regarding the nature of the use of an agent. There are stringent guidelines placed on all such publicly available compositions. Therefore, an agricultural fertilizer composition that can be used for a variety of purposes, including, horticultural, or fertilizing, is highly desirable.

### SUMMARY

One aspect of the application is directed to a composition comprising a ceramic matrix comprising a base ceramic material selected from the group consisting of alumina, perlite, titania, and silica, wherein the base ceramic material forms a ceramic matrix having a porous structure; and vegetative bacteria retained within the porous structure of the ceramic matrix, wherein the bacteria are selected from the group consisting of Bacillus cereus, Pseudomonas fluorescens, Rhodobacter sphaeroides, Rhizobia, Azospirillum, and Bacillus.

Another aspect of the application is directed to a composition comprising a ceramic matrix comprising a base ceramic material selected from the group consisting of alumina, perlite, and zirconia, wherein the base ceramic material forms a ceramic matrix having a porous structure; and bacterial spores and/or fungal spores, wherein the bacterial spores and/or fungal spores are retained within the porous structure of the ceramic matrix, wherein the bacterial spores are selected from the group consisting of Bacillus subtilis and Pseudomonas putida and wherein the fungal spores are selected from the group consisting of Mycorrhizal fungi and Trichoderma species.

Another aspect of the application is directed to an agricultural composition comprising a ceramic matrix comprising a base ceramic material selected from the group consisting of alumina, perlite, zirconia, and silica, wherein the base ceramic material forms a ceramic matrix having a porous structure; and a nanoparticle-enhanced formulation retained within the porous structure of the ceramic matrix, wherein the nanoparticle-enhanced formulation comprises nanoparticles selected from the group consisting of silver, gold, zinc oxide, chitosan, and liposomes.

Another aspect of the application is directed to a composition comprising a ceramic matrix comprising a base ceramic material selected from the group consisting of alumina, perlite, zirconia, and silica, wherein the base ceramic material forms a ceramic matrix having a porous structure; and a fertilizer retained within the porous structure of the ceramic matrix, wherein the liquid fertilizer comprises at least one nutrient selected from the group consisting of nitrogen, phosphorus, potassium, and trace micronutrients.

Another aspect of the application is directed to a method for improving soil health and plant growth. The method comprises the step of introducing a composition of the present application to agriculture soil.

Another aspect of the application is directed to a method for enhancing bioremediation in contaminated soil or water. The method comprises the step of applying a composition of the present application to a contaminated site.

Another aspect of the application is directed to a method for treating waste streams. The method comprises the step of incorporating a composition of the present application into a biofilter or bioreactor that interacts with and degrade pollutants in a waste stream.

Another aspect of the application is directed to a method for improving agricultural productivity. The method comprises the step of applying a composition of the present application to soil or plant surfaces.

These and other aspects and embodiments of the present application will become better understood with reference to the following detailed description when considered in association with the accompanying drawings and claims.

### BRIEF DESCRIPTION OF DRAWINGS

The figures herein are illustrative of non-limiting embodiments of the invention.

FIG. 1 illustrates the manufacture of a coated granular absorbent material loaded with absorbed fertilizer, and then the use of such material to fertilize soil.

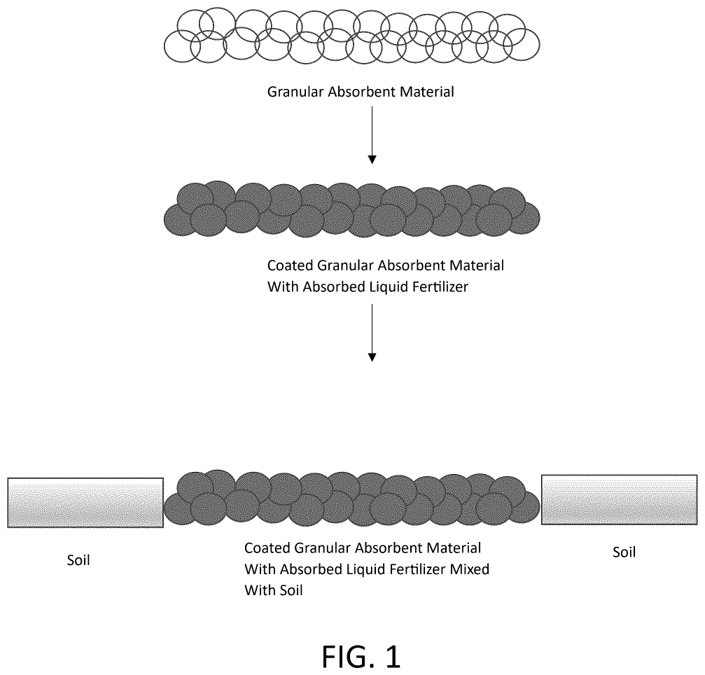

### DETAILED DESCRIPTION

The aspects of the application are described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

As used in this specification and the appended claims, the singular forms “a,” “an” and “the” include plural referents unless the content clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it is understood that the particular value forms another embodiment. It is further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to “the value,” greater than or equal to the value” and possible ranges between values are also disclosed, as appropriately understood by the skilled artisan. For example, if the value “10” is disclosed the “less than or equal to 10” as well as “greater than or equal to 10” is also disclosed.

### OVERVIEW

This application describes a novel, effective and low cost agricultural fertilizer composition that can be used for a variety of purposes, such as horticultural or fertilizers, farms. This application specifically provides a doped ceramic material formulated to improve soil quality by increasing moisture retention, enhancing aeration, and facilitating nutrient availability. The ceramic material is synthesized with specific dopants that modify its porosity, hydrophilicity, and ion exchange capacity. The doped ceramic is incorporated into agricultural soil through direct mixing or a spray application method. The doped ceramic material comprises a porous ceramic base doped with a variety of selected agents as described herein, including liquid fertilizers, vegetative bacteria, spores, nano-enhanced formulations, etc. These dopants are incorporated during the ceramic synthesis process to enhance specific soil-improving properties: porosity modification: improves water absorption and slow-release capabilities; ion exchange capacity: facilitates the gradual release of essential plant nutrients; and hydrophilic surface chemistry: increases the soil's ability to retain moisture without causing waterlogging. Upon application to soil, the doped ceramic material may provide one or more functions, including, but not limited to, absorbing excess water during irrigation or rainfall and gradually releases it during dry conditions, enhancing soil structure by improving aeration and reducing compaction, slowly releasing essential nutrients, reducing the need for frequent fertilizer applications, and promoting beneficial microbial activity due to its porous structure.

The doped ceramic material may be applied to soil in the variety of ways known to one of ordinary skill in the art, including but not limited to: (1) Direct Soil Mixing: The material is ground into fine granules or powder and mixed into the topsoil at a concentration of 1-5% by weight, depending on soil type and agricultural needs. The granules gradually integrate into the soil structure, providing long-term benefits; and (2) Spray Application: For ease of application over large areas, the doped ceramic material is suspended in a liquid carrier, such as water or an aqueous fertilizer solution. In certain embodiments, the suspension may be prepared as follows: the doped ceramic is milled to a micro- or nano-scale powder to ensure even dispersion; a dispersing agent, such as a biodegradable surfactant, is added to maintain suspension stability; the suspension is loaded into an agricultural sprayer and applied to the soil surface at a rate of, e.g., 50-200 liters per hectare; post-application irrigation may be conducted to aid penetration into the soil profile.

The doped ceramic material described herein provides advantages such as long-term efficacy, unlike organic amendments that degrade over time, the doped ceramic remains effective for multiple growing seasons. It is also sustainable and eco-friendly as it is made from natural minerals, it poses minimal environmental risks. The doped ceramic material described herein also results in reduced fertilizer dependence, as it enhances nutrient availability; thus, reducing the need for chemical fertilizers. The use of a doped ceramic in both granular and sprayable forms offers flexibility in application while ensuring long-term benefits for soil health and crop productivity.

### I. The Agricultural Fertilizer Composition

One aspect of the application relates to an agricultural fertilizer composition, comprising: (1) a granular absorbent material coated with a coating agent, wherein the coating agent forms a surface bonded film on the granular absorbent material, wherein the coating agent is selected from the group consisting of nano-enhanced formulations, liquid fertilizers, biostimulants, organic fertilizers, blood meal, cottonseed meal, feather meal, crab meal, synthetic fertilizers, fish emulsion, vegetative bacteria and stabilized bacteria in spore form, and soap bark from yucca plant and combinations thereof, and wherein the granular absorbent material is selected from the group consisting of ceramic minerals, zeolite, activated carbon, fumed silica, processed clays, cellulosic absorbents, fibrous absorbents and combinations thereof; and (2) an absorbable agent absorbed in said granular absorbent material, wherein the absorbable agent is selected from the group consisting of is selected from the group consisting of nano-enhanced formulations, liquid fertilizers, biostimulants, organic fertilizers, blood meal, cottonseed meal, feather meal, crab meal, synthetic fertilizers, fish emulsion, vegetative bacteria and stabilized bacteria in spore form, and soap bark from yucca plant and combinations thereof.

In some embodiments, the granular absorbent material is selected from the group consisting of ceramic minerals, zeolite, activated carbon, fumed silica, processed clays, cellulosic absorbents, fibrous absorbents and combinations thereof and wherein the absorbable agent is silane quaternary ammonium.

In some embodiments, the agricultural fertilizer composition is formulated for horticultural purposes, wherein the granular absorbent material is selected from the group consisting of ceramic minerals, zeolite, activated carbon, fumed silica, processed clays, cellulosic absorbents, fibrous absorbents and combinations thereof, wherein the coating agent is cleared silane or siloxane water repellant, and wherein the absorbable agent is a nano-enhanced formulation.

### The Granular Absorbent Material

The granular absorbent material can be any solid material with desired surface area, granulation, and absorbent characteristics. As used herein, the term “absorbent” or “adsorbent” is understood to mean a material that is capable of imbibing and holding onto aqueous fluids. Suitable granular absorbent materials include, but are not limited to, expanded and optimized ceramic minerals such perlite and vermiculite, zeolite, activated carbon, cellulosic absorbents and fibrous absorbents. In some embodiments, the granular absorbent material contains activated carbon, fumed silica, fine perlite, zeolites, processed clays or combinations thereof. The adsorbent/absorbent will exhibit clumping or matting characteristics for best performance and be well de-dusted. The granular absorbent material preferably has a surface area per mass or volume ratio. In some embodiments, the granular absorbent material has a surface area per mass ratio in the range of 100-10,000 m²/g, 100-9,000 m²/g, 100-8,000 m²/g, 300-8,000 m²/g, 1,000-8,000 m²/g, 2,000-8,000 m²/g, 3,000-8,000 m²/g, 4,000-8,000 m²/g, 5,000-8,000 m²/g, 6,000-8,000 m²/g, 7,000-8,000 m²/g, 100-7,000 m²/g, 300-7,000 m²/g, 1,000-7,000 m²/g, 2,000-7,000 m²/g, 3,000-7,000 m²/g, 4,000-7,000 m²/g, 5,000-7,000 m²/g, 6,000-7,000 m²/g, 100-6,000 m²/g, 300-6,000 m²/g, 1,000-6,000 m²/g, 2,000-6,000 m²/g, 3,000-6,000 m²/g, 4,000-6,000 m²/g, 5,000-6,000 m²/g, 100-4,000 m²/g, 300-4,000 m²/g, 1,000-4,000 m²/g, 2,000-4,000 m²/g, 3,000-4,000 m²/g, 100-3,000 m²/g, 300-3,000 m²/g, 1,000-3,000 m²/g, 2,000-3,000 m²/g, 100-2,000 m²/g, 300-2,000 m²/g, or 1,000-2,000 m²/g.

In some embodiments, the granular absorbent material has a surface area per mass ratio up to 10,000 m2/g. In some embodiments, the granular absorbent material has a surface area per mass ratio up to 9,000 m²/g. In some embodiments, the granular absorbent material has a surface area per mass ratio up to 8,000 m²/g. In some embodiments, the granular absorbent material has a surface area per mass ratio up to 7,000 m²/g. In some embodiments, the granular absorbent material has a surface area per mass ratio up to 6,000 m²/g.

In some embodiments, the granular absorbent material has a surface area per mass ratio of 100 m²/g or greater. In some embodiments, the granular absorbent material has a surface area per mass ratio of 300 m²/g or greater. In some embodiments, the granular absorbent material has a surface area per mass ratio of 1,000 m²/g or greater. In some embodiments, the granular absorbent material has a surface area per mass ratio of 2,000 m²/g or greater. In some embodiments, the granular absorbent material has a surface area per mass ratio of 3,000 m²/g or greater. In some embodiments, the granular absorbent material has a surface area per mass ratio of 4,000 m²/g or greater. In some embodiments, the granular absorbent material has a surface area per mass ratio of 5,000 m²/g or greater.

In some embodiments, the granular absorbent material has a surface area per mass ratio in the range of 1000-6,000 m²/g.

In some embodiments, the granular absorbent material contains ceramic materials.

In some embodiments, the granular absorbent material contains perlite and/or vermiculite.

In some embodiments, the granular absorbent material has a surface area per volume ratio in the range of 100-5,000 m²/ml, 300-5,000 m²/ml, 1,000-5,000 m²/ml, 2,000-5,000 m²/ml, 3,000-5,000 m²/ml, 4,000-5,000 m²/ml, 100-4,000 m²/ml, 300-4,000 m²/ml, 1,000-4,000 m²/ml, 2,000-54,000 m²/ml, 3,000-4,000 m²/ml, 100-3,000 m²/ml, 300-3,000 m²/ml, 1,000-3,000 m²/ml, 2,000-3,000 m²/ml, 100-2,000 m²/ml, 300-2,000 m²/ml, or 1,000-2,000 m²/ml.

In some embodiments, the granular absorbent material has a surface area per volume ratio up to 5,000 m²/ml. In some embodiments, the granular absorbent material has a surface area per volume ratio up to 4,000 m²/ml. In some embodiments, the granular absorbent material has a surface area per volume ratio up to 3,000 m²/ml.

In some embodiments, the granular absorbent material has a surface area per volume ratio of 100 m²/ml or greater. In some embodiments, the granular absorbent material has a surface area per volume ratio of 300 m²/ml or greater. In some embodiments, the granular absorbent material has a surface area per volume ratio of 1,000 m²/ml or greater. In some embodiments, the granular absorbent material has a surface area per volume ratio of 2,000 m²/ml or greater. In some embodiments, the granular absorbent material has a surface area per volume ratio in the range of 1000-3,000 m²/ml.

As used herein, the term “ceramics” or “ceramic material” shall mean compounds of nonmetallic elements possessing in general hardness, compressive strength, elastic modulus, thermal expansion and density. Exemplary ceramics include, but are not limited to, materials used in pottery, bricks, tiles, cements and glass, barium titanate, strontium titanate, bismuth strontium calcium copper oxide, boron oxide, boron nitride, earthenware, ferrite, lead zirconate titanate, magnesium diboride, porcelain, sialon, silicon carbodie, silicon nitride, steatite, titanium carbide, uranium oxide, yttrium barium copper oxide, zinc oxide, zirconium dioxide, and partially stabilized zirconia. Ceramics may be oxides (aluminia, beryllia, ceria, zirconia), nonoxides (carbide, boride, nitride, silicide) or composite materials (combinations of oxides and onoxides).

Perlite is a naturally occurring form of obsidian characterized by spherulites formed by cracking of volcanic glass during cooling. Perlite typically comprises a mix of silicon dioxide, aluminum oxide, sodium oxide, potassium oxide, iron oxide, magnesium oxide and calcium oxide. Potential substitutes for perlite include, but are not limited to, diatomite, expanded clay, shale, pumice, slag or vermiculite. Vermiculite is a naturally occurring hydrous phyllosilicate material, which is 2:1 clay.

Perlite holds water in one of three ways: in between individual grains, in channels leading to the cores of the grains and on the highly irregular surfaces of each particle. The surface of perlite is made up of the outer convex shells of glass bubbles and concave openings, so each particle can soak up a good amount of water. The amount of water taken up by particles of perlite is largely dependent on particle sizes. Just as fine, clay-rich soil holds more moisture than coarse, sandy soil, different particle size distributions of expanded perlite hold more moisture than others. Water mobility in perlite is excellent regardless of initial moisture levels due to relatively fast-acting capillary action. Drainage rates for perlite are another factor affected by the different densities, particle sizes and shapes of the various grades available. Larger particle sizes tend to drain more quickly, while finer grades naturally hold on to liquid for longer periods of time and drain more slowly. Perlite can be used for, amongst other non-limiting uses, in soilless growing media, seed starting, plant propagation, hydroponic growing, vegetated roofs, stormwater biofiltration, turf underlayment and native soil amendment. Perlite helps combat compaction in native soils and helps increase the level of healthy biological activity by increasing oxygen in the root zone. perlite readily gives up its water to plants, meaning plants expend less energy extracting water from growth substrates, and put more energy into root and vegetative development. And since perlite is derived from natural sources, growing media containing perlite can be composted or recycled after use.

As used herein, the term “zeolite” shall mean any of a large group of minerals comprising hydrated aluminosilicates of sodium, potassium, calcium and barium. Zeolite can occur naturally, but is also artificially synthesized. Exemplary zeolites include, but are not limited to, analcime, chabazite, clinoptilolite, heulandite, natrolite, phillipsite, and stilbite.

As used herein, the term “activated carbon” shall mean a form of carbon processed to have small, low-volume pores that increase the surface area available for adsorption or chemical reactions. A synonym for activated carbon is “activated charcoal.”

As used herein, the term “cellulosic absorbents” shall mean cellulose and cellulose derivatives that can provide structure, bulk, water-holding capacity and channeling of fluids over a wide dimensional range.

As used herein, the term “fibrous absorbents” refers to a fibrous structure with high void volume, a hydrophilic nature, and wet resiliency. Examples of fibrous absorbents include, but are not limited to, cotton fiber-based absorbents, corn fiber-based absorbents and hemp-based absorbents.

In some embodiments, the granular absorbent material constitutes 10-70% (w/w), 10-60% (w/w), 10-50% (w/w), 10-40% (w/w), 10-30% (w/w), 10-20% (w/w), 20-70% (w/w), 20-60% (w/w), 20-50% (w/w), 20-40% (w/w), 20-30% (w/w), 30-70% (w/w), 30-60% (w/w), 30-50% (w/w), 30-40% (w/w), 40-70% (w/w), 40-60% (w/w), 40-50% (w/w), 50-70% (w/w), 50-70% (w/w) or 60-70% (w/w) of the final product. In some embodiments, the granular absorbent material constitutes 25-30% (w/w) of the final product. In some embodiments, the granular absorbent material constitutes about 27% (w/w) of the final product.

In some embodiments, the agricultural fertilizer composition further comprises a agricultural or horticultural or fertilizer agent absorbed in the coated granular absorbent material. Examples of the agricultural or horticultural or fertilizer agent have been described herein.

In some embodiments, the agricultural or horticultural or fertilizer agent is a liquid phase agent. In some embodiments, the agricultural or horticultural or fertilizer agent is a liquid phase agricultural or horticultural or fertilizer agent.

Examples of liquid phase chemicals that can be used to inactivate or remove toxic chemicals include, but are not limited to, anionic surfactants such as soap, sulfonates and sulfates. In some embodiments, large quantities of water is used to dilute the toxic chemicals.

In some embodiments, the agricultural or horticultural or fertilizer agent constitutes 0.1 to 10% (w/w), 0.1 to 3% (w/w), 0.1 to 1% (w/w), 0.1 to 0.3% (w/w), 0.3 to 10% (w/w), 0.3 to 3% (w/w), 0.3 to 1% (w/w), 1 to 10% (w/w), 1 to 3% (w/w) or 3 to 10% (w/w) of the agricultural fertilizer composition.

### The Coating Agent

The coating agent can be any agricultural or horticultural or fertilizer agent capable of forming a coating layer on the surface of the granular absorbent material of the present application. In some embodiments, the coating agent is a liquid fertilizer. In some embodiments, the coating agent is a nano-enhanced formulation. In some embodiments, the coating agent is a polymer-based carrier. In some embodiments, the coating agent comprises a biocompatible material. Examples of biocompatible materials include, but are not limited to, polyvinyl alcohol and polycaprolactone. In some embodiments, the coating agent comprises an organic additive.

In some embodiments, the coating agent is an agricultural or horticultural or fertilizer agent that forms a surface bonded film on the granular absorbent material. The static surface bonded agricultural or horticultural or fertilizer agent film provides a long term desired effect in contact with the agricultural fertilizer composition of the present invention, thus providing a long term assurance of the effectiveness of the horticultural effect. In some embodiments, the coating agent is applied to the granular absorbent material by vapor deposition. In some embodiments, the vapor deposition is performed by thermal heating the coating agent and the granular absorbent.

In some embodiments, the coating agent is applied to the granular absorbent material by pressure micro droplet spray.

In some embodiments, the coating agent is applied to the granular absorbent material by a fuming or fogging nozzle.

In some embodiments, the coating agent is applied to the granular absorbent material by a deposition technique commonly used for metal plating.

In some embodiments, the coating agent is added in an amount that constitutes 0.1 to 10% (w/w), 0.1 to 5% (w/w), 0.1 to 2% (w/w), 0.1 to 1% (w/w), 0.1 to 0.5% (w/w), 0.3 to 10% (w/w), 0.3 to 5% (w/w), 0.3 to 2% (w/w), 0.3 to 1% (w/w), 1 to 10% (w/w), 1 to 5% (w/w), 1 to 2% (w/w), 2 to 10% (w/w), 2 to 5%, (w/w), 3 to 10% (w/w) or 3 to 5% (w/w) of the final product.

In some embodiments, the coating agent is added in an amount that constitutes 0.5 to 3.5% (w/w) or 1 to 3% (w/w) of the final product. In some embodiments, the coating agent is added in an amount that constitutes about 2% (w/w) of the final product.

### The Absorbable Agent

The agricultural or horticultural or fertilizer agent can be any agent having the desired activity and can be absorbed by the coated granular absorbent of the present application. The agricultural or horticultural or fertilizer agent comprises an active substance designed to act as a fertilizer. In some embodiments, the agricultural or horticultural or fertilizer agent is a liquid phase agent. In some embodiment, the agricultural or horticultural or fertilizer agent is a liquid phase chemical that inactivates or removes toxic chemicals, such as oil. In some embodiments, the liquid phase agricultural or horticultural or fertilizer agent is added at an application site to provide agricultural or horticultural for immediate response.

In some embodiments, the agricultural or horticultural or fertilizer agent is added in an amount that constitutes 0.1 to 10% (w/w), 0.1 to 3% (w/w), 0.1 to 1% (w/w), 0.1 to 0.3% (w/w), 0.3 to 10% (w/w), 0.3 to 3% (w/w), 0.3 to 1% (w/w), 1 to 10% (w/w), 1 to 3% (w/w) or 3 to 10% (w/w) of the final product.

In some embodiments, the agricultural or horticultural or fertilizer agent comprises dimethyl benzyl ammonium chloride or dimethyl ethybenzyl ammonium chloride. In some embodiments, the agricultural/horticultural agent comprises a mixture of dimethyl benzyl ammonium chloride or dimethyl ethybenzyl ammonium chloride. In some embodiments, the agricultural/horticultural agent is a 1:1 mixture of dimethyl benzyl ammonium chloride or dimethyl ethybenzyl ammonium chloride.

In some embodiments, the agricultural/horticultural agent comprises a quaternary amine and is added in an amount that constitutes 0.3 to 3% (w/w), 0.5 to 2% (w/w) or 0.5 to 1.5% (w/w) of the final product. In some embodiments, the agricultural or horticultural or fertilizer agent is a quaternary amine and is added in an amount that constitutes about 1% (w/w) of the final product.

In some embodiments, the agricultural or horticultural or fertilizer agent is a liquid phase agent. In some embodiments, the agricultural or horticultural or fertilizer agent is a liquid phase agricultural or horticultural or fertilizer agent.

Examples of liquid phase chemicals that can be used to inactivate or remove toxic chemicals include, but are not limited to, anionic surfactants such as soap, sulfonates and sulfates. In some embodiments, large quantities of water is used to dilute the toxic chemicals.

In some embodiments, the agricultural or horticultural or fertilizer agent constitutes 0.1 to 10% (w/w), 0.1 to 3% (w/w), 0.1 to 1% (w/w), 0.1 to 0.3% (w/w), 0.3 to 10% (w/w), 0.3 to 3% (w/w), 0.3 to 1% (w/w), 1 to 10% (w/w), 1 to 3% (w/w) or 3 to 10% (w/w) of the agricultural fertilizer composition.

In some embodiments, the agricultural or horticultural agent comprises dimethyl benzyl ammonium chloride or dimethyl ethybenzyl ammonium chloride. In some embodiments, the agricultural or horticultural agent comprises a mixture of dimethyl benzyl ammonium chloride or dimethyl ethybenzyl ammonium chloride. In some embodiments, the agricultural or horticultural agent is a 1:1 mixture of dimethyl benzyl ammonium chloride or dimethyl ethybenzyl ammonium chloride.

In some embodiments, the agricultural fertilizer composition further comprises one or more modifying agent. Examples of the agricultural or horticultural or fertilizer agent have been described herein. In some embodiments, the modifying agent comprises a thickening agent, a tackifier, a gum, an absorbent polymers or combinations thereof. In some embodiments, the one or more modifying agents comprise a carboxymethyl cellulose (CMC)-derived polymer and/or a hierarchically porous carbons (HPC)-derived polymer.

In some embodiments, the one or more modifying agents further comprise one or more additives selected from the group comprising denaturing agents, colorant agents, odor correctors, and/or pH regulators.

In some embodiments, the one or more modifying agents constitute 0.1 to 5% (w/w), 0.1 to 2% (w/w), 0.1 to 1% (w/w), 0.1 to 0.3% (w/w), 0.3 to 5% (w/w), 0.3 to 2% (w/w), 0.3 to 1% (w/w), 1 to 5% (w/w), 1 to 2% (w/w) or 2 to 5% (w/w) of the agricultural fertilizer composition.

In some embodiments, the agricultural fertilizer composition has a loading and coating capability in the range of 10-50% by volume, 15-45% by volume, 20-40% by volume, 25-35% by volume, or 25-30% by volume. In other embodiments, the agricultural fertilizer composition has a loading and coating capability of 100-400% by mass addition, 150-350% by mass addition, or 200-300% by mass addition. In some embodiments, the agricultural fertilizer composition of the present application is capable of absorbing liquid at a loading and coating of 25-30% by volume or 200-300% by mass addition.

### The Modifying Agent

The modifying agent is added to the coated granular absorbent or the absorbed-and-coated granular absorbent in an amount to achieve desired physical characteristics (e.g., non-dusty and clump, ease of pick up, liquid loadability, etc.) in the final product. Examples of the modifying agent include, but are not limited to, thickening agents, gums, absorbent polymers, tackifiers, and combinations thereof.

As used herein, the term “thickening agent” may include any material known or otherwise effective in providing suspending, gelling, viscosifying, solidifying or thickening properties to the composition or which otherwise provide structure to the final product form. These thickening agents may include gelling agents, polymeric or nonpolymeric agents, inorganic thickening agents, or viscosifying agents. The amount and type of the thickening agent may vary depending upon the desired characteristics of the final product.

As used herein, the term “tackifier” refers to polymeric adhesives which increases the tack, i.e., the inherent stickiness or self-adhesion, of the compositions so that after a short period of gentle pressure they adhere firmly to a surface. Examples of suitable tackifiers comprise high-flexibility resins such as, but not limited to, homopolymers of alkyl(meth)acrylates, especially alkyl acrylates, such as poly(isobutyl acrylate) or poly(2-ethylhexyl acrylate), linear polyesters, as commonly used for coil coating, linear difunctional oligomers, curable with actinic radiation, with a number average molecular weight of more than 2000, in particular from 3000 to 4000, based on polycarbonatediol or polyester-diol, linear vinyl ether homopolymers or copolymers based on ethyl, propyl, isobutyl, butyl and/or 2-ethylhexyl vinyl ether, or nonreactive urethane urea oligomers, which are prepared from bis(4,4-isocyanatophenyl)methane, N,N-dimethylethanolamine or diols such as propanediol, hexanediol or dimethylpentanediol.

In some embodiments, the modifying agent comprises a high-molecular substance that absorbs liquids, preferably water, swells, and finally is converted to a viscous true or colloidal solution.

In some embodiments, the modifying agent comprises one or more silicone gums. As used herein, the term “silicone gum” means a silicone polymer having a degree of polymerization sufficient to provide a silicone having a gum-like texture. In certain cases the silicone polymer forming the gum may be crosslinked.

In some embodiments, the modifying agent comprises a polymer. As used herein, Examples of the polymers include, but is not limited to, natural and synthetic polymers such as polyacrylamide (ACAM) and carboxymethyl cellulose.

In some embodiments, the polymers of the present application include, but are not limited to, polyacrylates such as sodium polyacrylates, and carboxymethyl cellulose.

In some embodiments, the modifying agent comprises one or more super-absorbent polymer. The term “super-absorbent polymer” is understood to mean hydrophilic polymer structure capable of absorbing water or saline solution at greater than 10 g of pure water/saline per gram of dry-based material (>10 g/g). Examples of super-absorbent polymers include, but are not limited to, sodium polyacrylates and carboxymethyl cellulose.

In some embodiments, the one or more modifying agents further comprise one or more additives selected from the group comprising denaturing agents, colorant agents, odor correctors, and/or pH regulators.

In certain preferred embodiments, the one or more modifying agents comprise sodium polyacrylate, a super absorbing polymer generally considered non-toxic and safe for humans. Sodium polyacrylate is, however, non-biodegradable. In some embodiments, for agriculture purposes only, the one or more modifying agents comprise potassium polyaspartate (KPA). Polyaspartate is a biopolymer synthesized from L-aspartic acid, a natural amino acid. It is biodegradable, environmentally friendly, retains soil moisture, and improves soil structure. Polyaspartate is approved as a food additive used as an anti-scaling additive in wine.

In some embodiments, the one or more modifying agents are added in an amount that constitute 0.1 to 5% (w/w), 0.1 to 2% (w/w), 0.1 to 1% (w/w), 0.1 to 0.3% (w/w), 0.3 to 5% (w/w), 0.3 to 2% (w/w), 0.3 to 1% (w/w), 1 to 5% (w/w), 1 to 2% (w/w) or 2 to 5% (w/w) of the final product.

### II. Method of Making

Another aspect of the present application relates to a method of making an agricultural fertilizer composition. In some embodiments, the method comprises the step of loading an absorbent material with an absorbable agent by mixing the coated absorbent material with the absorbable agent, wherein the absorbent material absorbs the absorbable agent to form a absorbed absorbent material. In some embodiments, the absorbent material is a granular absorbent material.

In some embodiments, the method comprises the steps of coating a granular absorbent material with a coating agent to produce a coated absorbent material; and loading the coated absorbent material with an absorbable agent by mixing the coated absorbent material with the absorbable agent, wherein the coated absorbent material absorbs the absorbable agent to form a coated and absorbed absorbent material. In some embodiments, the absorbable agent is an agricultural or horticultural or fertilizer agent. The agricultural or horticultural or fertilizer agent may be in a liquid or solid form. In some embodiments, the agricultural or horticultural or fertilizer agent is a liquid. Liquids (or substances often found in liquid form) that may be loaded (individually, combined, or in a multi-mix) on the coated absorbent material described herein may be varied according to desired effect, and encompass the liquid form of the agricultural or horticultural or fertilizer agents described herein.

In some embodiments, the method further comprises the step of grinding an absorbent material to produce the granular absorbent material used in the coating step. In some embodiments, the method further comprises the step of drying the coated absorbent material prior to the mixing step. In some embodiments, the method further comprises the step of adding one or more modifying agent to the coated and absorbed absorbent material in amounts sufficient to achieve desired physical characteristics (e.g., non-dusty and clump, ease of pick up, loading and coating capacity, etc.).

In some embodiments, the granular absorbent material is selected from the group consisting of ceramic materials, zeolite, activated carbon, fumed silica, processed clays, cellulosic absorbents, fibrous absorbents and combinations thereof, the coating agent is a nano-enhanced formulation, and the absorbable agent is a nano-enhanced formulation in a liquid form.

The agricultural fertilizer composition described herein may be used in many applications, such as horticultural systems.

### III. Method of Use

An aspect of the application is a method for soil or plant fertilization, comprising the steps of: applying an effective amount of the agricultural fertilizer composition described herein in powder form to soil or plants in need of fertilization.

An aspect of the application is a method for horticultural growth, comprising the steps of: applying an effective amount of the agricultural fertilizer composition described herein in powder form to an exposed surface.

In certain embodiments, the method comprises the steps of applying an effective amount of the agricultural fertilizer composition of the present application to a surface in need of horticultural, agricultural or fertilizing activity and removing the agricultural fertilizer composition after a period of time.

In some embodiments, the period of time is from 30 seconds to 30 minutes. In some embodiments, the period of time is from 1 to 30 minutes, from 1 to 20 minutes, from 1 to 10 minutes, from 2 to 30 minutes, from 2 to 20 minutes, from 2 to 10 minutes, from 5 to 30 minutes, from 5 to 20 minutes and from 5 to 10 minutes.

In some embodiments, the agricultural fertilizer composition of the present application is a multi-phase product that can be used to fertilize through a number of different mechanisms.

### IV. Kits

Another aspect of the present application relates to a horticultural kit. In some embodiments, the kit contains the agricultural fertilizer composition of the present application and instructions on how to use the agricultural fertilizer composition.

In some embodiments, the kit further contains a copy of OSHA guidelines. In some embodiments, the kit further contains one or more of the following: biohazard bags, gloves, twist tie, antimicrobial hand wipe, germicidal wipe, scoop/scraper.

The horticultural kit can be conveniently placed in locations within quick reach of all caregivers. For example; all patient and chemotherapy rooms, case & crash carts, emergency vehicles, cafeteria, environmental services closets, and within or near first aid kits, etc.

In certain embodiments, the application discloses a specialized coating method of a non-toxic bio static film on a high surface area solid, such as a granular absorbent material.

The following examples are offered by way of illustration of certain embodiments of aspects of the application herein. None of the examples should be considered limiting on the scope of the application.

### EXAMPLES

### Example 1—Agricultural Applications

The agricultural fertilizer composition described herein may absorb liquid plant nutrients for use in farming and other plant growth contexts, such as landscape gardening. In certain embodiments, fertilizers that may be liquid-loaded to the composition described herein include, without limitation, liquid fertilizers, biostimulants, organic fertilizers, blood meal, cottonseed meal, feather meal, crab meal, synthetic fertilizers (e.g., Miracle-Gro® fertilizers), or fish emulsion; vegetative bacteria and stabilized bacteria in spore form, soap bark from the yucca plant.

In certain embodiments, an agricultural fertilizer composition, comprising: a granular absorbent material coated with a coating agent, wherein the coating agent forms a surface bonded film on the granular absorbent material, and wherein the granular absorbent material is selected from the group consisting of ceramic minerals, zeolite, activated carbon, fumed silica, processed clays, cellulosic absorbents, fibrous absorbents and combinations thereof; and an absorbable agent absorbed in said granular absorbent material, wherein the composition is capable of absorbing liquid at a liquid loading of 25-30% by volume or 200-300% by mass addition.

In some embodiments, the coating agent is a liquid fertilizer.

In some embodiments, the absorbable agent is selected from the group consisting of is selected from the group consisting of liquid fertilizers, biostimulants, organic fertilizers, blood meal, cottonseed meal, feather meal, crab meal, synthetic fertilizers, fish emulsion, vegetative bacteria and stabilized bacteria in spore form, and soap bark from yucca plant and combinations thereof.

In certain embodiments, this application discloses a method of formulating an agricultural fertilizer composition, comprising the steps of: coating a granular absorbent material with a coating agent to produce a coated absorbent material, wherein the coating agent forms a surface bonded film on the granular absorbent material, and wherein the granular absorbent material is selected from the group consisting of ceramic minerals, zeolite, activated carbon, fumed silica, processed clays, cellulosic absorbents, fibrous absorbents and combinations thereof; and mixing the coated absorbent material with an absorbable agent, wherein the coated absorbent material absorbs the absorbable agent to form the composition, wherein the absorbable agent is a liquid.

In some embodiments, the granular absorbent material comprises ceramic minerals. In some embodiments, the ceramic minerals comprise perlite and/or vermiculite. In specific embodiments, the coating agent is a liquid fertilizer.

In certain embodiments, the absorbable agent is selected from the group consisting of is selected from the group consisting of liquid fertilizers, biostimulants, organic fertilizers, blood meal, cottonseed meal, feather meal, crab meal, synthetic fertilizers, fish emulsion, vegetative bacteria and stabilized bacteria in spore form, and soap bark from yucca plant and combinations thereof.

In some embodiments, the coating agent is a liquid fertilizer.

In some embodiments, the liquid fertilizer is UAN (urea and ammonium nitrate mixture).

In certain embodiments, the method is further comprising the step of: grinding an absorbent material to produce the granular absorbent material used in the coating step.

In certain embodiments, the absorbable agent is selected from the group consisting of liquid fertilizers, biostimulants, organic fertilizers, blood meal, cottonseed meal, feather meal, crab meal, synthetic fertilizers, fish emulsion, vegetative bacteria and stabilized bacteria in spore form, and soap bark from yucca plant and combinations thereof.

### Example 2—Doped Ceramic Material Coated and Loaded with Liquid Fertilizer

In this application, the doped ceramics described herein comprise nutrient formulations that can be encapsulated or combined with materials like perlite that control their release over time. The specific nutrients in these fertilizers depend on the intended use (e.g., nitrogen for leafy growth, phosphorus for root development, or potassium for overall plant health). In certain embodiments, the nutrients commonly contained in slow-release carriers and the types of fertilizers may be: Nitrogen-Based Slow-Release Fertilizers; Nitrogen is a primary nutrient required for vegetative growth, and slow-release nitrogen fertilizers are widely used to provide a steady supply of this essential element. Common nitrogen sources in slow-release carriers include: Urea: Coated with polymers, sulfur, or other materials to control release; Ammonium Sulfate: Often used in polymer-coated or sulfur-coated formulations; Ammonium Nitrate: Encapsulated for controlled release; Urea-Formaldehyde (UF): A synthetic slow-release nitrogen source; Isobutylidene Diurea (IBDU): A slow-release nitrogen compound; and Methylene Urea: A stabilized nitrogen form used in liquid slow-release fertilizers.

In certain embodiments, the doped ceramic described herein may be loaded with Phosphorus-Based Slow-Release Fertilizers; Phosphorus is essential for root development, flowering, and fruiting. Slow-release phosphorus fertilizers include: Rock Phosphate: A natural mineral that releases phosphorus slowly as it weathers; Monoammonium Phosphate (MAP): Coated or encapsulated for controlled release; Diammonium Phosphate (DAP): Used in slow-release formulations for crops requiring phosphorus; Polyphosphate: A polymerized form of phosphate used in some slow-release products.

In certain embodiments, the doped ceramic described herein may be loaded with Potassium-Based Slow-Release Fertilizers; Potassium is critical for overall plant health, stress tolerance, and fruit quality. Slow-release potassium fertilizers include: Potassium Sulfate: Coated or encapsulated for controlled release; Potassium Chloride: Used in slow-release formulations for crops tolerant to chloride; Greensand: A natural mineral that releases potassium slowly over time; and Langbeinite: A mineral source of potassium, magnesium, and sulfur.

In certain embodiments, the doped ceramic described herein may be loaded with Multi-Nutrient Slow-Release Fertilizers; Many slow-release fertilizers contain a combination of nitrogen, phosphorus, and potassium (NPK) to provide balanced nutrition.

In certain embodiments, a doped granular ceramic as described herein is coated and loaded with a liquid fertilizer. Liquid fertilizer is a type of fertilizer that is made up of water, nitrogen, and other plant nutrients. Liquid fertilizers commonly used are UAN (urea and ammonium nitrate mixture) containing 28, 30, and 32 mass % N; anhydrous ammonia, which contains 82 mass % N; superphosphoric acid, which is a concentrated form of phosphoric acid with a grade of 0-70-0; and ammonia reacted with superphosphoric acid to produce a liquid fertilizer of 10-34-0 or 11-37-0 grade. Different liquid grades of fertilizer can be produced using a variety of chemicals for grades similar to the dry fertilizer grades. Organic fertilizers are fertilizers that are naturally produced. Typical organic fertilizers include all animal waste including meat processing waste, manure, slurry, and guano; plus plant based fertilizers such as compost; and biosolids. Inorganic “organic fertilizers” include minerals and ash. Organic fertilizers are naturally available mineral sources that contain moderate amount of plant essential nutrients. They are capable of mitigating problems associated with synthetic fertilizers. They reduce the necessity of repeated application of synthetic fertilizers to maintain soil fertility. They gradually release nutrients into the soil solution and maintain nutrient balance for healthy growth of crop plants. They also act as an effective energy source of soil microbes which in turn improve soil structure and crop growth. Organic fertilizers are generally thought to be slow releasing fertilizers and they contain many trace elements. They are safer alternatives to chemical fertilizers.

Synthetic fertilizers are man-made, inorganic fertilizers. They are normally derived from the by-products of the petroleum industry and include such ingredients as potassium sulfate, ammonium phosphate, superphosphate, and ammonium nitrate.

Most synthetic fertilizers do not contain as many of the micronutrients that plants frequently require for healthy growth. Synthetic fertilizers tend to be made up of a combination of nitrogen, phosphorus, potassium, and sulfur.

### Example 3—Doped Ceramic Material Coated and Loaded with Nano-Enhanced Formulations

Conventional delivery systems for bioactive compounds often suffer from limitations such as rapid degradation, poor solubility, and inefficient targeting. This application addresses these challenges by utilizing a doped ceramic matrix that encapsulates nanoparticle-enhanced formulations, allowing for sustained release and improved bioavailability. The doped ceramic may be formed from a base ceramic material (such as alumina, perlite, zirconia, or silica) that is doped with specific ions (e.g., calcium, magnesium, or titanium) to enhance its mechanical strength, porosity, and surface reactivity. The doping process may be executed through techniques such as sol-gel synthesis or solid-state reaction, ensuring a uniform distribution of dopants throughout the ceramic matrix. Nanoparticle-enhanced formulations may include nanoparticles of metals (e.g., silver, gold, or zinc oxide) or organic nanoparticles (e.g., chitosan or liposomes) designed to improve the stability and efficacy of bioactive compounds such as vitamins, antioxidants, or antimicrobial agents. These formulations may be loaded into the porous structure of the doped ceramic through methods such as centrifugation, spray drying, or freeze-drying, maximizing the retention of nanoparticles within the matrix. A protective coating may then be applied to the ceramic composite, composed of biocompatible materials (such as polyvinyl alcohol or polycaprolactone) to facilitate controlled release and protect the bioactive compounds from environmental degradation.

The doped ceramic composite can be utilized in various fields, including: pharmaceuticals for enhancing the delivery of drugs to target sites for improved therapeutic effects with reduced side effects; agriculture for providing a slow-release formulation of nutrients or pesticides that increases effectiveness while minimizing environmental impact; for environmental remediation for utilizing the composite for the targeted delivery of agents that degrade pollutants in soil or water. The doped ceramic matrix offers mechanical stability and protection for the nanoparticle-enhanced formulations, ensuring their viability and effectiveness over time. The controlled release mechanism allows for prolonged activity of bioactive compounds, enhancing their bioavailability and reducing the frequency of applications. The use of nanoparticles enhances the solubility and stability of bioactive agents, leading to greater efficacy in targeted applications.

In a particular embodiment, a doped granular ceramic as described herein is coated and loaded with LSN 32-0-0 (Total Nitrogen 32% (16.2% Urea Nitrogen; 7.9% Ammoniacal Nitrogen; 7.9% Nitrate Nitrogen)); this produces a nano-enhanced doped ceramic, which may be applied to leaf surfaces or directly to soil.

In a particular embodiment, another nano-enhanced doped granular ceramic as described herein is coated and loaded with Brix Up Liquid Brown Sugar with Humic and Kelp (Humic acid (derived from leonardite) 0.078%; Sugar Cane Extract (microbe food) 48%), which adds complex carbohydrates in the form of bio-available sugar to plants.

In a particular embodiment, another nano-enhanced doped granular ceramic as described herein is coated and loaded with Soil Zyme (Soluble Potash 2%; Sulfur 2%; Boron 0.02%; Copper 0.4%; Iron 0.75%; Manganese 0.48%; Zinc 1% (derived from sulfate EDTA; Potassium Sulfate; Copper Sulfate; Boric Acid; Zinc Sulfate; Seaweed Extract; Chelating Agent; Ethylenedlaminetetraacetic Acid); which also contains (Humic acid (derived from leonardite) 2%; Molasses (microbe food) 20%; Kelp and Seaweed Extract (Ascophyllum nodosum) 5%).

### Example 4—Doped Ceramic Material Coated and Loaded with Biostimulants

Traditional methods of applying biostimulants often result in rapid degradation or leaching, leading to reduced effectiveness and the need for frequent applications. This application described herein addresses these challenges by utilizing a doped ceramic matrix that encapsulates biostimulants, enabling sustained release and improved interaction with plant roots and soil microbiota. The doped ceramic may be formulated from a base ceramic material (such as alumina, perlite, silica, or titania) that is doped with specific ions (e.g., calcium, magnesium, or iron) to enhance its structural integrity, porosity, and nutrient retention capacity. The doping process may be executed through techniques such as sol-gel synthesis or thermal treatment, ensuring even distribution of the dopants within the ceramic matrix. Biostimulants, such as humic acids, seaweed extracts, or beneficial microorganisms (like mycorrhizae), may be selected for their ability to promote plant growth and enhance nutrient uptake. The biostimulants may be loaded into the porous structure of the doped ceramic using methods such as soaking, mixing, or spray drying, ensuring maximum retention of the active compounds within the matrix. A protective coating made from biodegradable materials (such as chitosan, alginate, or starch) may then be applied to the ceramic composite, which facilitates controlled release of the biostimulants while protecting them from environmental degradation.

The doped ceramic loaded with biostimulants composite can be utilized in various agricultural and horticultural practices, including: soil improvement for enhancing soil fertility and microbial activity, promoting healthier plant growth; crop management for providing a slow-release source of biostimulants that improve seed germination, root development, and overall plant vigor; sustainable agriculture for supporting eco-friendly farming practices by reducing the frequency of biostimulant applications and minimizing nutrient runoff. The doped ceramic matrix offers mechanical stability and protection for biostimulants, ensuring their viability and effectiveness over time. The controlled release mechanism allows for prolonged activity of biostimulants, reducing the risk of leaching and enhancing plant availability. The biodegradable coating contributes to environmental sustainability while fostering a healthy soil ecosystem.

In certain embodiments, a doped granular ceramic as described herein is coated and loaded with a biostimulant.

Biostimulants are substances and/or microorganisms whose function when applied to plants or the rhizosphere is to stimulate natural processes to benefit nutrient uptake, nutrient use efficiency tolerance to abiotic stress, and/or crop quality, independently of its nutrient content.

Biostimulants that are used in conjunction with the agricultural fertilizer composition described herein include:

(1) Humic and fulvic acids—parts of soil organic matter resulting from the decomposition of plant, animal, and microbial residues. e.g. peat, mineral deposits of leonardite and soft coal. Humic substances are collections of heterogeneous compounds, originally categorized according to their molecular weights and solubility into humins, humic acids and fulvic acids.

(2) Seaweed Extracts Derived through different extraction processes. Soluble powders or liquid. In agriculture, the type most commonly used is ascophylum Nodosum, Fucus spp, Laminaria spp, Sargassum spp, and Turbinaria spp. Seaweed extracts act as biostimulants mainly due to the presence of plant hormones. Main phytohormones identified in seaweed extracts are: auxins, cytokinins, gibberelins, abscisic acid and ethylene.

(3) Liquid manure composting—made by mixing manure water and a blend of materials that feed specific bacteria in the manure. This provides adequate conditions for microbial growth. The liquid is then used as a biofertilizer, which is coated and loaded on the composition described herein.

(4) Beneficial bacteria and fungi—concentration of bacteria and/or fungi in the soil that help with root growth. e.g. Bacillus and Rhizobium fungi. There are two large families of microorganisms—beneficial fungi and beneficial bacteria. The first category is strongly represented by Micorrhizal fungi. These fungi work in a mutualistic symbiose, between plant roots and some fungi of the soil. Mycorrhizal fungi colonize the plant roots and provide them mineral elements and water they extract from soil through an external net of hyphae, whilst the plant supplies the micro-organism with radical organic compounds and sugar. Mycorrhizae are produced by in vivo or in vitro techniques. The first one ensures that the fungi are grown as in natural conditions and by consequence are more resistant on the soil conditions. Some other fungi (like some strains of Trichoderma) stimulate plant development and increase plant productivity. They are also able to induce the formation of rootlets and stimulate the colonization of the rhizosphere and root by other beneficial micro-organisms. Beneficial bacteria settle by association within the rhizosphere. They will act mainly on the nutrition functions of plants—in particular on the increase in the absorption of minerals, and better resistance to abiotic stress. The main products offered on the market are rhizobium and plants growth-promoting rhizobacteria.

### Example 5—Doped Ceramic Material Coated and Loaded with Meal

Traditional agricultural practices often involve the direct application of organic meals to soil or crops, which can lead to nutrient loss due to leaching and volatilization. This application addresses these challenges by utilizing a doped ceramic matrix that encapsulates organic meal, allowing for sustained nutrient release and improved efficacy in various agricultural settings. In certain embodiments, the doped ceramic may be composed of a base ceramic material (such as alumina, perlite, silica, or zirconia) that is doped with specific ions (e.g., calcium, magnesium, or potassium) to enhance its mechanical properties, porosity, and ion exchange capacity. The doping process may be achieved using methods such as sol-gel synthesis or thermal treatment, ensuring a uniform distribution of dopants throughout the ceramic matrix. Organic meal (e.g., soybean meal, alfalfa meal, or canola meal) rich in essential nutrients may be selected for loading into the doped ceramic. The meal may be loaded into the porous structure of the doped ceramic through methods such as spray drying, mixing, or soaking, maximizing the incorporation of nutrients within the matrix. After loading, the ceramic composite may be coated with a biodegradable polymer or bio-based material (such as starch or chitosan) to create a protective layer that facilitates controlled nutrient release while preventing premature degradation.

The doped ceramic loaded with meal composite described herein can be utilized in various agricultural practices, including: soil fertilization for providing a slow-release nutrient source that improves soil fertility and plant growth; crop management for enhancing the nutrient availability to crops over an extended period, reducing the need for frequent fertilization applications; sustainable agriculture for supporting environmentally friendly farming practices by minimizing nutrient runoff and improving soil health. The doped ceramic matrix ensures mechanical stability and protects the organic meal from environmental degradation, maintaining nutrient integrity. The controlled release mechanism allows for sustained nutrient availability, reducing the risk of nutrient leaching and enhancing crop productivity. The biodegradable coating minimizes environmental impact while promoting soil health and microbial activity.

In a certain embodiment, a doped granular ceramic as described herein is coated and loaded with meal.

Blood meal is a dry, inert powder made from blood, used as a high-nitrogen organic fertilizer and a high protein animal feed. N=13.25%, P=1.0%, K=0.6%. It is one of the highest non-synthetic sources of nitrogen. It usually comes from cattle or hogs as a slaughterhouse by-product.

Cottonseed meal is the byproduct of oil extraction from cotton seeds. They are mainly used for acid-loving plants such as rhododendrons, blueberries, and azaleas. Several methods are used to extract cottonseed oil such as mechanical extraction, direct solvent extraction process, prepress solvent extraction resulting in different types of cottonseed meal having difference in protein, fiber, and oil content. Naturally obtained cotton seed meal fertilizers are applied prior to planting to treat high soil pH to replace depleted trace elements in the soil. This fertilizer has an N to K ratio of 6:4. Due to its high nutrient content it can be used as a perfect nitrogen fertilizer.

Feather meal protein-rich concentrate generated for poultry feed can also be applied for organic farming as a semi-slow release nitrogen fertilizer. Biodegradation of poultry processing waste is an alternative avenue for creating a viable end product with visible benefits to the primary producers in the environmental and economic strategies. Feather meal being nitrogen rich (15% N), inexpensive, and readily available sources serves as a potential substitute to guano. It not only supplies nitrogen to plants and promotes microbial activity, but also structures the soil and increase water retention capacity. The microbial hydrolyzed feather meal can further edge over the steamed meal as fertilizer due to its high nutritive value, easy production, and economic feasibility. The simplest and most appropriate application of recycled keratin wastes and other organic wastes is as cheap soil amendments and fertilizers providing organic matter, an important constituent of biologically active and productive soils. It is therefore promising to develop ecologically friendly methods for more effective utilization of keratin wastes to obtain new organic amendments and fertilizers for improving quality of agricultural soils.

Crab meal organic fertilizer is the kiln dried shell of the crab that has been ground down to dust. Crab meal has a protein in it called chitin. This protein make up is what makes the crab meal an organic fertilizer. By itself, it's organic and loaded with nitrogen, phosphorous, calcium and magnesium. It is slow release which is healthier for plants and it also helps with nematode and fungus problems in the soil because it is also high in chitin. It encourages soil microorganisms to discharge enzymes called chitinases, which break down the chitin that are a part of the nematode egg shell. Crab meal can be considered a bio-pesticide (preventing, destroying or repelling) for this reason. Crab meal provides a slow release of nitrogen to the soil.

In a certain embodiments, a doped granular ceramic as described herein is coated and loaded with fish emulsion, which is a quick-acting organic liquid fertilizer made from byproducts of the fish oil and fish meal industry.

### Example 6—Doped Ceramic Material Coated and Loaded with Bacterial or Fungal Spores

This application in certain embodiments relates to a novel doped ceramic composite that is utilized for the controlled release of bacterial spores, aimed at improving biodegradation processes in various environments. The doped ceramic matrix enhances the stability and viability of the bacterial spores, allowing for applications in wastewater treatment, soil remediation, and bioremediation of contaminated environments. The doped ceramic may be composed of a base ceramic material (such as alumina, perlite, or zirconia) that is doped with specific ions (e.g., calcium, magnesium, or silica) to enhance its mechanical properties and increase its surface area. The doping process may be performed using sol-gel or solid-state synthesis techniques, ensuring uniform distribution of the dopants. Bacterial spores (e.g., Bacillus subtilis or Pseudomonas putida) are selected for their biodegradation capabilities. The spores may be loaded into the porous structure of the doped ceramic through immersion or vacuum infiltration methods, allowing for maximum uptake. Following loading, the bacterial spores may be coated with a biocompatible polymer (such as chitosan or alginate) to form a protective layer. This coating facilitates controlled release and protects the spores from environmental stressors.

In a certain embodiment, a doped granular ceramic as described herein is coated and loaded with bacterial spores. The doped ceramic loaded with spores described herein may be used in wastewater treatment for enhancing the degradation of organic pollutants in municipal and industrial wastewater systems; soil remediation for accelerating the breakdown of pollutants in contaminated soils, providing a sustainable approach to environmental cleanup; or bioremediation for utilizing the doped ceramic as a slow-release microbial inoculant in areas affected by oil spills or heavy metal contamination. The doped ceramic described herein offers improved stability and viability of bacterial spores compared to traditional formulations; it also provides a controlled release mechanism, ensuring prolonged activity of the bacterial agents. The biocompatible coating protects the spores from adverse environmental conditions, thereby enhancing their effectiveness in biodegradation applications.

In certain embodiments, the doped ceramic described herein may be loaded with fungi, such as, Mycorrhizal Fungi: Forms symbiotic relationships with plant roots, improving nutrient and water uptake; and Trichoderma: Protects plants from fungal pathogens and enhances root growth.

Bacterial spores are small oval or spherical structures that are very resistant to high temperatures, radiation, desiccation, and chemical agents. When they are formed intracellularly, they are called endospore. The bacterial cell producing spore is called vegetative cell. The spore is formed as a response to adverse conditions. Bacterial spore is a resistant structure to unfavorable environmental conditions. Each cell produces only one spore and each spore germinate to one vegetative cell. The spore is just a part of the life cycle of spore forming bacteria under unfavorable conditions. Many rhizospheric bacterial strains possess plant growth-promoting mechanisms. These bacteria can be applied as biofertilizers in agriculture and forestry, enhancing crop yields. Bacterial biofertilizers can improve plant growth through several different mechanisms: (i) the synthesis of plant nutrients or phytohormones, which can be absorbed by plants, (ii) the mobilization of soil compounds, making them available for the plant to be used as nutrients, (iii) the protection of plants under stressful conditions, thereby counteracting the negative impacts of stress, or (iv) defense against plant pathogens, reducing plant diseases or death. Several plant growth-promoting rhizobacteria (PGPR) have been used worldwide for many years as biofertilizers, contributing to increasing crop yields and soil fertility and hence having the potential to contribute to more sustainable agriculture and forestry.

Carrier materials are used as vehicles for the bacteria in the formulation of the biofertilizer. There are different kinds of substances suitable for use as carriers, i.e. clay, talc, peat, vermiculite, perlite, bentonite, zeolite, diatomaceous earth, rice or wheat bran, rock phosphate pellets, charcoal, soil, sawdust or compost. Usually, the selection of the carrier material is made on the basis of the longer viability of the bacteria transported (not only during storage, but also after the application of the biofertilizer to the soil) and the desired type of application (liquid, powder, granulated or as a seed coating); the price of the material is another important factor affecting choice. Apart from these, other desirable characteristics for a good carrier are: (i) it should allow the addition of bacterial nutrients, (ii) it must have a high water-holding capacity, (iii) it should allow easy sterilization, (iv) it must have a good pH buffering capability, (v) it must be non-pollutant and biodegradable and (vi) it must allow easy handling by the farmer. It is difficult to find a natural product exhibiting all these properties.

In certain embodiments, a granular ceramic as described herein is coated and/or loaded with polymer-based carriers, which encapsulate the bacteria in their matrix and release them gradually in the soil during their degradation process. The best-known are alginate beads. Alginate, a natural polymer of D-mannuronic and L-glucuronic acids derived from macroalgae such as Macrocystis pyrifera or Sargassum sinicola, forms beads when added to a cationic solution. Alginate beads have a diameter of 2-3 mm with a pore size of 0.005-0.2 mm and are frequently used for microbial cell encapsulation. Microalginate beads with a diameter of 100-200 μm have proved to be a good carrier for the immobilization of Azospirillum brasilense (>1011 cfu/g inoculant) and the biofertilizer produced enhanced wheat and tomato crops. Another process for the storage and application of bacterial bioproducts uses water-in-oil emulsions. Bacteria in water-in oil emulsions can be applied to the crops through irrigation systems.

The carrier is previously sterilized and then mixed with liquid culture of the bacteria with a high number of viable cells per milliliter, usually between 108-109 CFU/ml. To produce the bacterial culture, inocula containing pure cultures of the desired PGPR strains plus growth media containing the bacterial nutrients are placed in fermentors. In many cases, consortia of diverse bacteria with different plant growth-promotion mechanisms have resulted in higher crop yields because they act synergically. Accordingly, many commercial biofertilizers contain more than one bacterial strain. Sometimes, bacterial and fungal strains are combined, with excellent results.

In certain embodiments, a doped granular ceramic as described herein is coated and loaded with yucca soap bark, which is a natural soap containing ground Yucca glauca root as one of the ingredients. Yucca contains the healthy and beneficial elements of resveratrol, yuccaols, and saponins. Saponins are natural surfactants and wetting agents. Saponins reduce surface tension, hence facilitating the spread of fertilizer solution onto an entire leaf. When applied onto the soil with liquid starters, Yucca bark extract acts as a wetting agent reducing the formation of dry spots or water channels. This improves nutrients and water uptake in the root zone.

### Example 7—Doped Ceramic Coated and Loaded with Vegetative Bacteria

Conventional methods for introducing vegetative bacteria into soil or contaminated sites often face challenges related to the survival and efficacy of the microorganisms under environmental stress. This application in certain embodiments addresses these challenges by employing a doped ceramic matrix that protects and sustains vegetative bacteria, ensuring their effective performance in targeted applications.

The doped ceramic is formulated from a base ceramic material (such as alumina, perlite, titania, or silica) that is doped with beneficial ions (e.g., calcium, strontium, or iron) to enhance its mechanical strength, porosity, and surface reactivity. The doping process is achieved through methods such as sol-gel synthesis or hydrothermal treatment, ensuring homogeneity in the dopant distribution.

In particular embodiments, selected vegetative bacteria (e.g., Bacillus cereus, Pseudomonas fluorescens, or Rhodobacter sphaeroides) known for their bioremediation and plant growth-promoting properties are utilized. The bacteria may be loaded into the porous structure of the doped ceramic through techniques such as centrifugation, spray drying, or freeze-drying, which maximizes bacterial retention within the matrix. A protective coating made from biocompatible materials (such as chitosan, alginate, or polyvinyl alcohol) may then be applied to the surface of the doped ceramic, encapsulating the vegetative bacteria and providing a controlled release mechanism.

The doped ceramic with vegetative bacteria composite can be employed in various fields, including: bioremediation for enhancing the degradation of organic and inorganic pollutants in contaminated water and soil environments; agriculture for improving soil health and fertility by promoting plant growth through the application of beneficial vegetative bacteria that enhance nutrient availability and uptake; waste management for utilizing the composite in biofilters or bioreactors to treat waste streams and reduce environmental pollutants effectively. The doped ceramic matrix provides enhanced mechanical stability and protects vegetative bacteria from environmental stressors, ensuring their viability. In certain embodiments, the controlled release of bacteria from the composite allows for sustained activity over extended periods, improving the effectiveness of bioremediation and agricultural practices. The biocompatible coating enhances bacterial survival rates and promotes interaction with surrounding soil or water environments.

Plant root probiotics, also known as plant growth-promoting rhizobacteria (PGPR), are beneficial microorganisms that colonize plant roots and enhance plant growth, health, and resilience. These probiotics play a critical role in sustainable agriculture by improving soil health, reducing the need for chemical fertilizers, and protecting plants from pathogens.

In certain embodiments, the doped ceramic described herein can be loaded with bacteria, such as, Rhizobia: Nitrogen-fixing bacteria that form nodules on legume roots; Azospirillum: Promotes root growth and nitrogen fixation; Pseudomonas: Produces growth hormones and protects against pathogens; and Bacillus: Enhances nutrient availability and suppresses soil-borne diseases.

While various embodiments have been described above, it should be understood that such disclosures have been presented by way of example only and are not limiting. Thus, the breadth and scope of the subject compositions and methods should not be limited by any of the above-described exemplary embodiments, but should be defined only in accordance with the following claims and their equivalents.

The above description is for the purpose of teaching the person of ordinary skill in the art how to practice the object of the present application, and it is not intended to detail all those obvious modifications and variations of it which will become apparent to the skilled worker upon reading the description. It is intended, however, that all such obvious modifications and variations be included within the scope of the present application, which is defined by the following claims. The aspects and embodiments are intended to cover the components and steps in any sequence, which is effective to meet the objectives there intended, unless the context specifically indicates the contrary.

What is claimed is:

1. A composition comprising:
a ceramic matrix comprising a base ceramic material selected from the group consisting of alumina, perlite, titania, and silica, wherein the base ceramic material forms a ceramic matrix having a porous structure; and
vegetative bacteria retained within the porous structure of the ceramic matrix, wherein the bacteria are selected from the group consisting of Bacillus cereus, Pseudomonas fluorescens, Rhodobacter sphaeroides, Rhizobia, Azospirillum, and Bacillus.

2. The composition of claim 1, further comprising a biocompatible coating encapsulating the ceramic matrix, wherein the coating is selected from the group consisting of chitosan, alginate, and polyvinyl alcohol, wherein the biocompatible coating provides a controlled release mechanism for the vegetative bacteria.

3. A method for enhancing bioremediation in contaminated soil or water, comprising:
applying the composition of claim 1 to a contaminated site, wherein vegetative bacteria released from the ceramic matrix facilitate the degradation of organic or inorganic pollutants.

4. A method for improving soil health and plant growth, comprising:
introducing the composition of claim 1 into agricultural soil, wherein vegetative bacteria released from the ceramic matrix colonize in plant root zone and promote nutrient uptake, nitrogen fixation, and pathogen suppression in plants.

5. The method of claim 4, wherein the composition is applied in the form of granules, powder, or coated pellets.

6. A method for treating waste streams, comprising:
incorporating the composition of claim 1 into a biofilter or bioreactor, wherein the vegetative bacteria to interact with and degrade pollutants in the waste stream.

7. A composition, comprising:
a ceramic matrix comprising a base ceramic material selected from the group consisting of alumina, perlite, and zirconia, wherein the base ceramic material forms a ceramic matrix having a porous structure; and
bacterial spores and/or fungal spores, wherein the bacterial spores and/or fungal spores are retained within the porous structure of the ceramic matrix, wherein the bacterial spores are selected from the group consisting of Bacillus subtilis and Pseudomonas putida and wherein the fungal spores are selected from the group consisting of Mycorrhizal fungi and Trichoderma species.

8. The composition of claim 7, further comprising a biocompatible polymer coating encapsulating the ceramic matrix, wherein the polymer coating is selected from the group consisting of chitosan and alginate, wherein the biocompatible polymer coating provides a controlled release mechanism for the bacterial spores and/or fungal spores.

9. A method for treating wastewater, comprising:
introducing the composition of claim 7 into a wastewater treatment system, wherein the bacterial spores and/or fungal spores are released from the ceramic matrix, germinate and facilitate the biodegradation of organic pollutants in the wastewater system.

10. A method for soil remediation, comprising:
applying the composition of claim 7 to a contaminated soil environment, wherein the bacterial spores and/or fungal spores are released from the ceramic matrix, germinate and degrade pollutants in the soil.

11. The composition of claim 7, wherein the ceramic matrix is coated with a polymer-based carrier selected from the group consisting of alginate beads and water-in-oil emulsions.

12. The composition of claim 7, wherein the ceramic matrix is coated with yucca soap bark extract.

13. An agricultural composition, comprising:
A ceramic matrix comprising a base ceramic material selected from the group consisting of alumina, perlite, zirconia, and silica, wherein the base ceramic material forms a ceramic matrix having a porous structure; and
a nanoparticle-enhanced formulation retained within the porous structure of the ceramic matrix, wherein the nanoparticle-enhanced formulation comprises nanoparticles selected from the group consisting of silver, gold, zinc oxide, chitosan, and liposomes.

14. The agricultural composition of claim 13, further comprising a biocompatible coating encapsulating the ceramic matrix, wherein the biocompatible coating is selected from the group consisting of polyvinyl alcohol and polycaprolactone, wherein the biocompatible coating facilitates controlled release of the nanoparticle-enhanced formulation.

15. A method for improving agricultural productivity, comprising:
applying the agricultural composition of claim 13 to soil or plant surfaces, wherein the agricultural composition comprises nanoparticle-enhanced formulation comprising nutrients or pesticide and allows controlled release of nutrients or pesticide from the ceramic matrix.

16. The method of claim 15, wherein the nanoparticle-enhanced formulation comprises LSN 32-0-0.

17. The method of claim 15, wherein the nanoparticle-enhanced formulation comprises (1) Brix Up Liquid Brown Sugar with Humic and Kelp or (2) Soil Zyme.

18. A composition comprising:
a ceramic matrix comprising a base ceramic material selected from the group consisting of alumina, perlite, zirconia, and silica, wherein the base ceramic material forms a ceramic matrix having a porous structure; and
a fertilizer retained within the porous structure of the ceramic matrix, wherein the liquid fertilizer comprises at least one nutrient selected from the group consisting of nitrogen, phosphorus, potassium, and trace micronutrients.

19. The composition of claim 18, wherein the fertilizer comprises:
(1) a nitrogen-based component selected from the group consisting of urea, ammonium sulfate, ammonium nitrate, urea-formaldehyde, isobutylidene diurea (IBDU), and methylene urea; and/or
(2) a phosphorus-based component selected from the group consisting of rock phosphate, monoammonium phosphate (MAP), diammonium phosphate (DAP), and polyphosphate; and/or
(3) a potassium-based component selected from the group consisting of potassium sulfate, potassium chloride, greensand, and langbeinite; and/or
(4) an organic fertilizer selected from the group consisting of manure, slurry, guano, compost, biosolids, ash and naturally occurring mineral sources; and/or
(5) a synthetic fertilizer selected from the group consisting of potassium sulfate, ammonium phosphate, superphosphate, and ammonium nitrate; and/or
(7) UAN (urea and ammonium nitrate mixture) with a nitrogen content of 28%, 30%, or 32%; and/or
(8) superphosphoric acid with a grade of 0-70-0 or a liquid fertilizer produced from ammonia reacted with superphosphoric acid with a grade of 10-34-0 or 11-37-0.

20. The composition of claim 18, further comprising a biocompatible coating encapsulating the ceramic matrix, wherein the biocompatible coating is selected from the group consisting of polyvinyl alcohol and polycaprolactone.

21. A method for enhancing agricultural productivity, comprising:
applying the composition of claim 18 to soil or plant surfaces.
